(19) United States
(12) Patent Application Publication
(10) Pub. No.: US 2016/0109191 A1
(43) Pub. Date: Apr. 21, 2016

(54) Cooling Module with Integral Surge Tank

(71) Applicant: Modine Manufacturing Company, Racine, WI (US)

(72) Inventors: Jerzy Skrzyniarz, Muskego, WI (US); Matthew J Hernigle, Greenfield, WI (US)

(21) Appl. No.: 14/918,666

(22) Filed: Oct. 21, 2015

Related U.S. Application Data
(60) Provisional application No. 62/066,472, filed on Oct. 21, 2014.

(51) Int. Cl. F28F 9/00; B23P 15/26

(52) U.S. Cl. CPC F28F 9/001; B23P 15/26

(57) ABSTRACT

A cooling module includes multiple heat exchangers, at least one of which is a coolant radiator. The cooling module further includes a structural frame channel extending along an end of the cooling module, with the heat exchangers being at least partially secured to the structural frame channel. A coolant surge tank is integral to the cooling module, and is in fluid communication with the coolant radiator. The coolant surge tank has a coolant volume bounded by several walls, and at least one of those walls is provided by the structural frame channel. A method of making the cooling module is also described.

### CROSS-REFERENCE TO RELATED APPLICATIONS

This application claims priority to United States Provisional Patent Application No. 62/066,472 filed Oct. 21, 2014, the entire contents of which are hereby incorporated by reference herein.

### BACKGROUND

The present invention relates to cooling modules, and particularly relates to cooling modules for engine systems.

### SUMMARY

According to an embodiment of the invention, a cooling module includes multiple heat exchangers, at least one of which is a coolant radiator. The cooling module further includes a structural frame channel extending along an end of the cooling module, with the heat exchangers being at least partially secured to the structural frame channel. A coolant surge tank is integral to the cooling module, and is in fluid communication with the coolant radiator. The coolant surge tank has a coolant volume bounded by several walls, and at least one of those walls is provided by the structural frame channel.

In some embodiments, the frame channel defines a planar wall extending along a width dimension of the cooling module. The heat exchangers and the coolant surge tank are, in some embodiments, located on a common side of the planar wall. In some such embodiments the coolant surge tank is arranged between the planar wall and the coolant radiator.

In some embodiments, each of the heat exchangers includes a heat exchanger core, and the structural frame channel is non-overlapping with any of the heat exchanger cores.

In some embodiments the structural frame channel includes a first, a second, and a third wall that bound the coolant volume. The first wall has two opposing long edges, and the second wall extends along one of the long edges and is perpendicular to the first wall. The third wall extends along the other of the long edges and is also perpendicular to the first wall. In some embodiments a coolant fill neck is joined to the first wall and extends into the coolant volume.

According to another embodiment of the invention, a cooling module is installed into an engine system that has a coolant circuit. The cooling module includes a top structural frame channel, and a bottom structural frame channel that is spaced apart from, and is lower than, the top structural frame channel. The cooling module further includes a coolant radiator and a coolant surge tank. The coolant radiator is arranged between, and is secured to, the top and bottom structural frame channels, and forms part of the cooling circuit. The coolant surge tank is provided within the top structural frame channel, and is located above the coolant radiator. The coolant surge tank also forms part the cooling circuit.

In some embodiments the coolant surge tank is located at an uppermost position along the coolant circuit. In some embodiments one or more additional heat exchangers are also secured to the top and bottom structural frame channels

In some embodiments the coolant radiator includes an inlet tank and an outlet tank. The coolant surge tank is fluidly coupled to either the inlet tank or the outlet tank by way of a vent port provided at an upper location of the coolant surge tank. In some such embodiments the inlet tank is secured to the top structural frame channel and the outlet tank is secured to the bottom structural frame channel.

In some embodiments the coolant surge tank is fluidly coupled to a lowermost location along the cooling circuit by way of a draw-down port provided at a lower location of the coolant surge tank.

In some embodiments the top structural frame channel has a first and a second U-shaped section. The first U-shaped section is defined by a horizontally arranged planar wall joined by two vertically arranged planar walls. The second U-shaped section is also defined by a horizontally arranged planar wall joined by two vertically arranged planar walls, and is received within and joined to the first U-shaped section to define the coolant surge tank.

According to another embodiment of the invention, a method of making a cooling module includes forming mounting holes in a metal sheet, and forming the metal sheet into a first U-shaped component. The method further includes forming a second metal sheet into a second U-shaped component, and arranging that second U-shaped component within the first U-shaped component. The first and second U-shaped components are joined to define an enclosed volume. A coolant radiator is joined to the first U-shaped component through the mounting holes.

### BRIEF DESCRIPTION OF THE DRAWINGS

FIG. 1 is a perspective view of a cooling module according to an embodiment of the invention.

FIG. 2 is an exploded perspective view of the cooling module of FIG. 1.

FIG. 3A and 3B are perspective views of a structural frame member of the cooling module of FIG. 1.

FIG. 4 is a partial plan sectional view along the lines IV-IV of FIG. 3A.

FIG. 5 is an exploded perspective view of the structural frame member of FIGS. 3A and 3B.

FIG. 6 is a diagrammatic view of an engine cooling system making use of a cooling module according to an embodiment of the invention.

### DETAILED DESCRIPTION

Before any embodiments of the invention are explained in detail, it is to be understood that the invention is not limited in its application to the details of construction and the arrangement of components set forth in the following description or illustrated in the accompanying drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

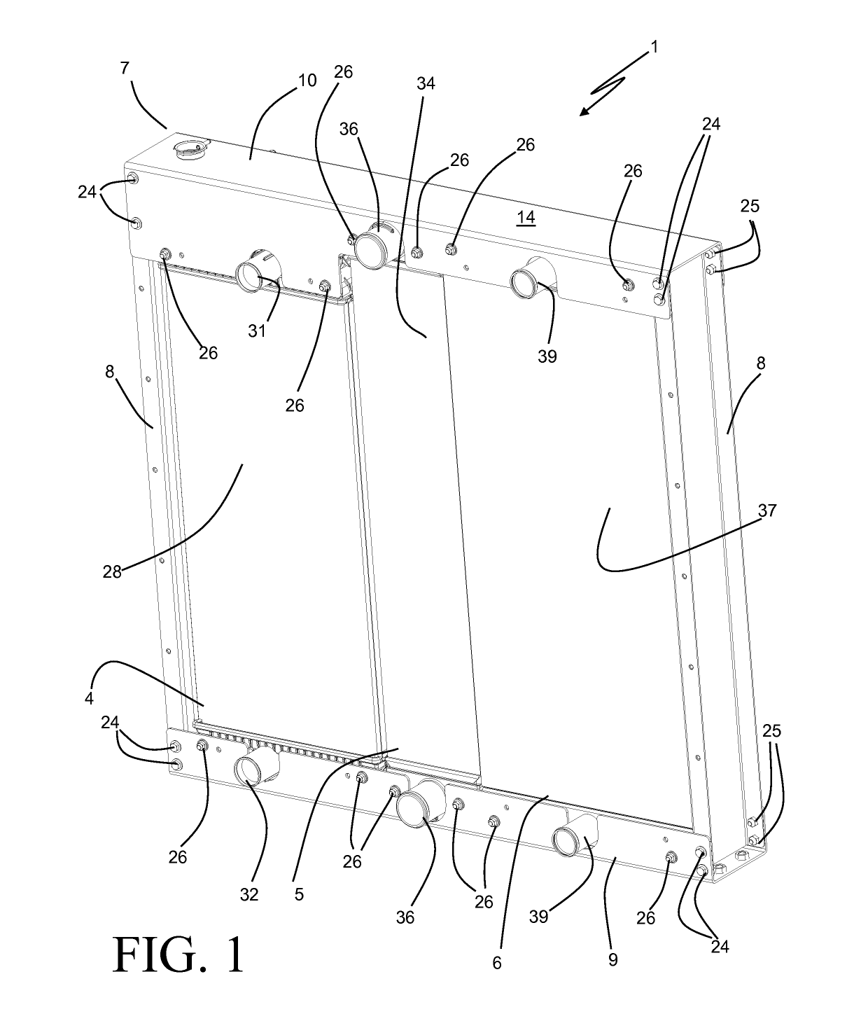

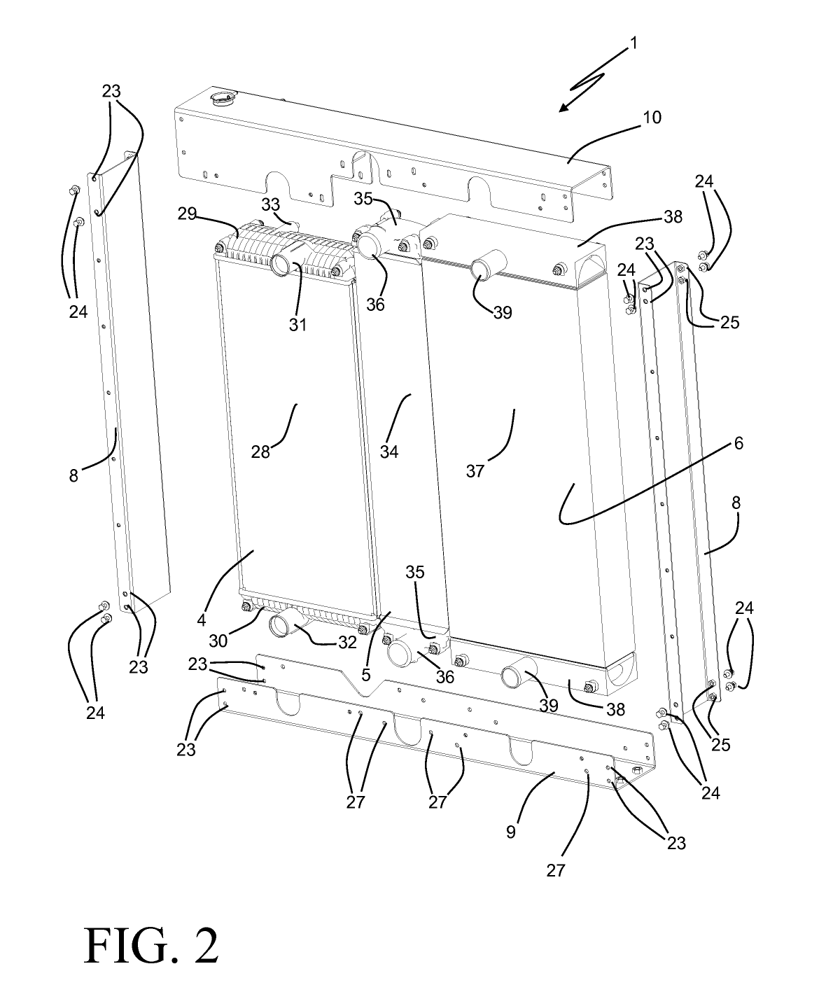

A cooling module 1 according to some embodiments of the invention is shown in FIGS. 1 and 2, and includes multiple (in the exemplary embodiment, three are shown) heat exchangers arranged to receive a flow of cooling air. The cooling module 1 includes a radiator 4 for rejecting heat from a flow of liquid engine coolant, a charge-air cooler 5 for rejecting heat from turbo-charged combustion air, and an oil cooler 6 for rejecting heat from transmission oil. While the exact number and types of heat exchangers may vary by application, the cooling module 1 as shown can find particular utility in engine applications for off-highway equipment such as excavators, front-end loaders, and the like. The coolant radiator 4, charge air cooler 5, and oil cooler 6 are arranged in series along a width dimension of the cooling module 1. Additional heat exchangers (such as, for example, a condenser) can optionally be included as well but are not shown.

While the style and construction of each of the heat exchangers included in the module 1 can vary, each is generally shown as having a heat exchange core extending between tanks arranged at opposing sides. As best seen in the exploded view of FIG. 2, the radiator 4 includes a top tank 29 arranged at the upper end of the radiator 4, a bottom tank 30 arranged at the lower end of the radiator 4, and a radiator heat exchange core 28 extending between the top tank 29 and the bottom tank 30. The top tank 29 is provided with an inlet port 31 to receive a flow of coolant from an engine coolant system, and the bottom tank 30 is provided with an outlet port 32 to return the cooled coolant back to the engine coolant system.

In similar fashion, the charge air cooler 5 includes opposing tanks 35 separated and connected by a charge air cooler heat exchange core 34, and the oil cooler 6 includes opposing tanks 38 separated and connected by an oil cooler heat exchange core 37. Ports 36 are provided in each of the charge air cooler tanks 35, and ports 39 are provided in each of the oil cooler tanks 38, to allow for connection into their respective fluid systems. Each of the heat exchangers 4, 5, and 6 are depicted as single pass heat exchangers, but it should be understood that multi-pass heat exchanger can alternatively be employed for one or more of the heat exchangers, and that the respective inlet and outlet ports of a heat exchanger can alternatively be provided within a single one of the tanks

The radiator core 28, the charge air cooler core 34, and the oil cooler core 37 all provide fluid pathways (for the fluid to be cooled) extending between the opposing tanks of the heat exchanger, as well as air flow passages for cooling air extending through the core. Each of the heat exchange cores 28, 34, and 37 can be constructed in any of the manners known in the art, including (without limitation): tube and fin construction, round tube plate fin construction, bar plate construction, and brazed plate construction.

A structural frame 7 having a top structural frame channel 10, a bottom structural frame channel 9, and two side structural frame channels 8, is used to secure the heat exchangers within the cooling module 1. The structural frame 7 is assembled around the collected heat exchangers, and the various members of the structural frame 7 are secured by threaded bolts or similar fasteners 24 extending though aligned holes 23 in the frame members and coupled to threaded nuts or similar fasteners 25 at the corners of the structural frame 7. The holes 23 can preferably be provided in pairs at each corner, as shown, to provide improved rigidity of the structural frame 7. The heat exchangers are secured to the frame members by way of fasteners 26 that extend through heat exchanger mounting holes 27 provided in the top structural frame channel 10 and the bottom structural frame channel 9 in order to be secured within or through the tanks of the heat exchangers.

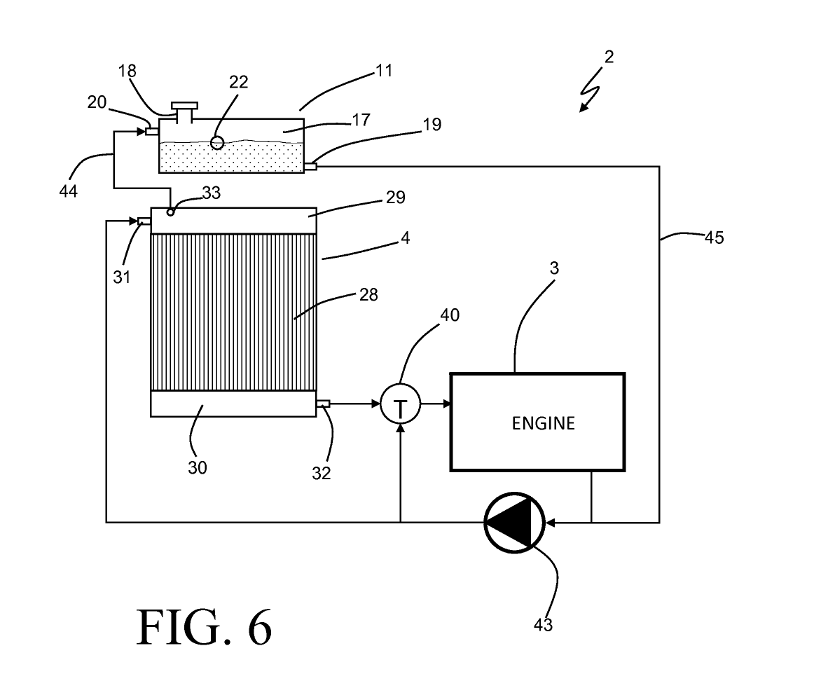

Turning now to the diagram of FIG. 6, the engine coolant system 2 of which the radiator 4 is a part will be described in some detail. The engine coolant system 2 primarily operates to maintain the temperature of an engine 3 within desired operational parameters. The engine 3 is typically an internal combustion engine operating on a fuel such as gasoline, diesel, natural gas, propane, or other hydrocarbon-based fuel, although other types of engines may be suitable in some applications. A flow of coolant is circulated through the engine 3 by a water pump 43 in order to transport away the heat that is generated by inefficiencies in the power generating process of the engine 3. Any number of liquid coolants are known in the art, including water, ethylene glycol propylene glycol, and combinations thereof. However, it should be understood that the operating principles of the engine cooling system 2 are generally applicable to any number of liquid coolants.

As the engine coolant absorbs the generated heat from the engine 3, it becomes necessary to reject that heat from the flow of coolant in order to maintain the coolant temperature at desirable levels. This rejection of heat is at least partially achieved by the radiator 4. At least some of the heated coolant is directed to the top tank 29 of the radiator 4, from where it flows through the radiator heat exchange core 28 to the bottom tank 30. Air is also directed through the radiator heat exchange core 28 by, for example, a fan. Heat is convectively transferred from the coolant to the air, so that the temperature of the coolant is reduced.

A thermostat 40 is used to maintain the temperature of the coolant entering the engine 3 within a desirable operating range. A typical thermostat 40 includes a wax motor element that is disposed within the coolant flow and is responsive to the temperature of the coolant flow. During conditions when the coolant is below the desired operating temperature range (as might occur, for example, during startup of the engine or during operation in very cold ambient temperatures) the thermostat will completely or substantially prevent the flow of coolant from the outlet tank 30 of the radiator 4, so that all or substantially all of the coolant delivered to the engine 3 for cooling purposes is sourced directly from the water pump 43, without having passed through the radiator 4. Such an operation will prevent, or at least severely limit, the removal of heat from the coolant, so that continued operation of the engine 3 will serve to steadily increase the coolant temperature until such time as the coolant achieves a temperature that is within the desired operational limits. At such a time, the thermostat 40 will partially open the flow path extending through the radiator 4 to coolant flow, so that at least some of the coolant circulated by the water pump 43 is cooled by the rejection of heat to air in the radiator 4. In some operating conditions the thermostat 40 can completely open the flow path extending through the radiator 4, so that all or substantially all of the coolant circulated by the water pump 43 passes through the radiator. Generally speaking, though, the thermostat 40 will continuously modulate the split between coolant passing through the radiator 4 and coolant bypassing the radiator, in order to provide the engine 3 with a continuous flow of coolant at a desired temperature.

It is well-known that typical liquid coolants exhibit an inverse correlation between temperature and density. As one particularly relevant but non-limiting example, raising the temperature of a 50/50 (by volume) mixture of water and ethylene glycol from 5° C. to a typical operating temperature of 90° C. will result in a 5% decrease in the liquid density. This decrease in density results in an overall expansion of the volume occupied by the generally incompressible liquid coolant, and requires that some expansion space be provided within the coolant system 2. The requisite expansion space can be provided by a surge tank 11 included in the coolant system 2. The surge tank 11 is preferably located at the highest point in the coolant system 2, and provides an expansion space filled with a compressible gas (typically air). As the coolant is heated by the engine 3 from a relatively cold temperature in non-operating conditions to the relatively warm temperature found in steady-state operation, the expansion of the coolant within the coolant system 2 will drive some of the coolant into the surge tank 11 through a draw-down port 19 that is provided at a bottom end of the surge tank 11. The draw-down port 19 is fluidly coupled by a draw-down line 45 to the suction side of the water pump 43, although in some alternative embodiments it may instead be coupled at a different point along the coolant circuit, for example the high-pressure side of the water pump 43. The movement of coolant into the internal volume 17 of the surge tank 11 will raise the liquid level and compress the gas, thereby increasing the system pressure. Upon stoppage of the engine 3, the coolant within the coolant system 2 will cool and again increase in density. This will then cause some of the coolant contained within the surge tank 11 to move into the remainder of the coolant system 3 through the draw-down port 19.

The surge tank 11 can also be used to prevent the undesirable accumulation of air and other non-condensable gases within other regions of the engine coolant system 2. The accumulation of air within, for example, fluid passages of the radiator heat exchange core 28 can result in those passages being effectively blocked from receiving coolant flow, thereby leading to inadequate cooling capacity. To prevent such accumulation, a radiator vent port 33 is provided within the top tank 29 of the radiator 4, and is fluidly connected by a vent line 44 to a vent port 20 arranged towards the upper end of the surge tank 11. Pockets of air throughout the engine coolant system 2 will be carried to the top tank 29 by the flow of coolant from the water pump 43, or will naturally make their way there from the bottom tank 30 and/or the heat exchange core 28 by buoyancy effects. The natural buoyancy of the air relative to the engine coolant will further cause the air to migrate upward into the volume 17 of the surge tank 11. Any coolant that may be carried along with the air will rejoin the additional coolant stored within the volume 17.

The aforementioned venting arrangement can be especially useful in filling the engine coolant system 2 with coolant. It can be highly desirable to fill the engine coolant system 2 through the surge tank 11, as it is the portion of the engine coolant system 2 that is of the highest elevation. To that end, a fill neck 18 is provided at the top of the surge tank 11. The fill neck 18 can be closed off with a pressure-capable cap (not shown) during operation of the system, the cap being easily removable for filling of the system 2 with coolant. Coolant can be dispensed into the coolant system 2 through the fill neck 18, and such coolant will drain to the bottom of the engine coolant system 2 by way of the draw-down port 19. Air that is displaced by the coolant filling the system will be pushed into the top tank 29, which is preferably located at a higher elevation than all other parts of the system 2 other than the surge tank 11. The air is then further displaced into the surge tank 11 through the vent port 20, and is allowed to leave the system through the fill neck 18. A sight glass 22 can be provided in the surge tank 11, at a location corresponding to a desirable fill level of the surge tank. The sight glass 22 provides visual feedback during the filling operation, such that filling can be halted when the level of coolant can be observed through the sight glass 22. The sight glass 22 is preferably arranged at an elevation that is higher than the drawdown port 19 and lower than the vent port 20, so that the port 19 can be in fluid communication with the liquid-containing portion of the surge tank 11, and the port 20 can be in fluid communication with the air-containing portion.

An overflow port 21 is provided in the fill neck 18. During operation, the central bore of the fill neck is closed off by the pressure cap at a location below the overflow port 21. The pressure cap includes a pressure-relieving mechanism, so that if the pressure within the coolant system 2 exceeds some pre-defined threshold, the pressure is relieved by venting air and/or coolant through the overflow port 21, thereby reducing the pressure and preventing damage to the coolant system 2.

Challenges can be encountered in locating the surge tank within an engine system, especially when that engine system is provided as part of an off-highway vocational vehicle. It can be desirable to package at least some of the heat exchangers for such an engine system into a cooling module, and it is frequently not desirable to have the surge tank extend above the top of such a module. However, as previously indicated, proper operation of the engine coolant system 2 requires that the surge tank is located at the uppermost elevation of the engine coolant system 3.

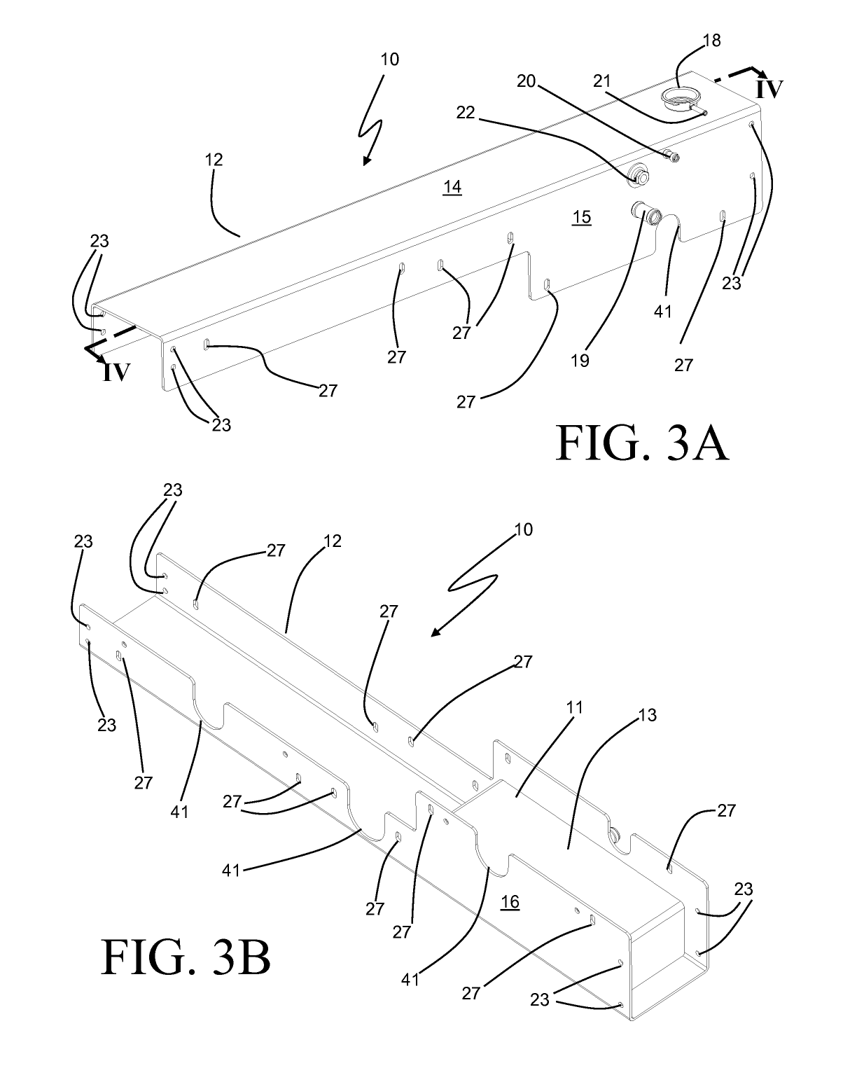

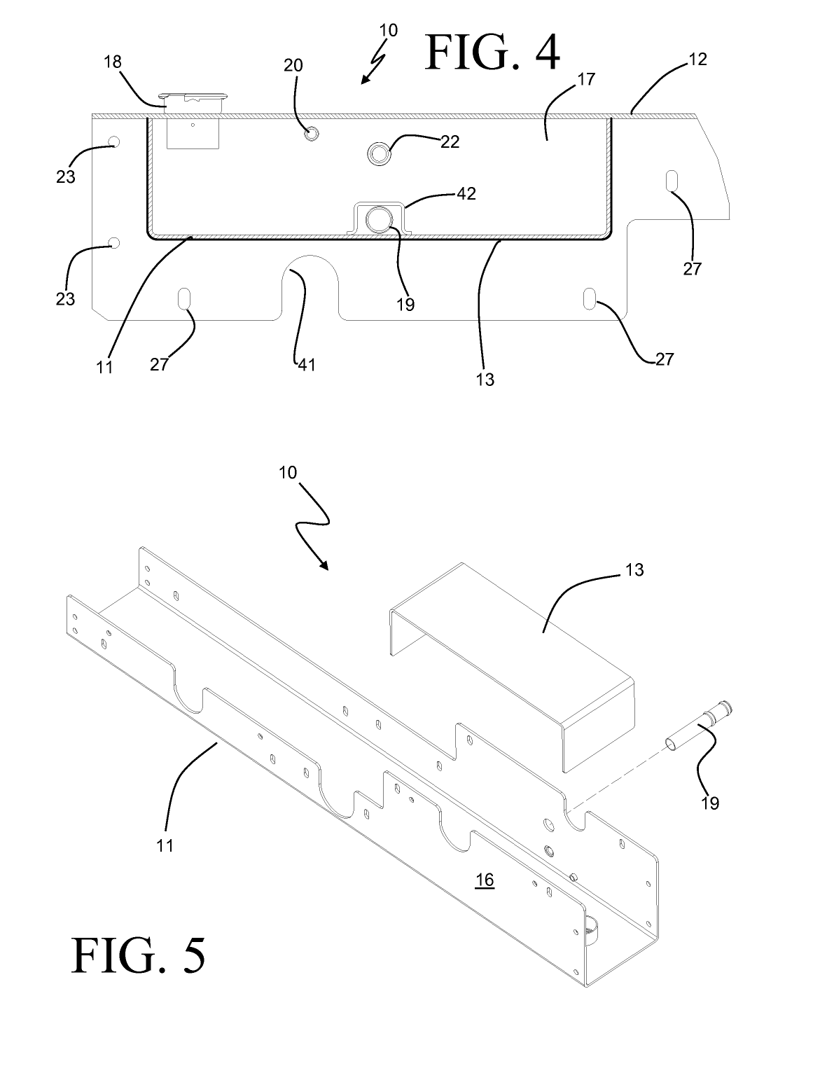

In order to solve the aforementioned challenge, the surge tank 11 is integrated into the structural frame 7 of the cooling module 1. Specifically, the top structural frame channel 10 is provided with an integrated surge tank 11 that is situated directly above the top tank 29 of the radiator 4. Features of the top structural frame channel 10 can best be understood with reference to FIGS. 3A, 3B, 4, and 5.

The top structural frame channel 10 of the exemplary embodiment is formed of sheet steel. However it should be understood that in other embodiments it may be formed of other materials such as aluminum or plastic.

The top structural frame channel 10 includes a first U-shaped component 12 and a second U-shaped component 13. By “U-shaped”, it is meant that the component has three joined wall sections joined end to end such that two of the wall sections are arranged generally parallel to and aligned with each other, and are joined by a central one of the wall sections to define a shape that is generally similar to the letter U. The component 10 includes a central planar wall 14 extending between two parallel, spaced apart planar walls 15, 16. The planar wall 15 is joined to a first long edge of the planar wall 14, and the planar wall 16 is joined to an opposing second long edge of the planar wall 14. The planar walls 15, 16 are arranged to be perpendicular to the planar wall 14, and extend from the planar wall 14 in a common direction so that the component 10 is generally of a U-shape when viewed along the direction of the long edges.

In a preferable embodiment, the cooling module 1 will be designed such that the depths of the heat exchangers 4, 5 and 6 are generally the same. The spacing between the walls 15, 16 is of a dimension that readily accommodates the tanks 29, 35, and 38 therebetween, and allows for secure attachment of those tanks to the top structural frame channel 10 by the heat exchanger fasteners 26 that extend through heat exchanger mounting holes 27 provided in the walls 15, 16. The heat exchanger mounting holes 27 are arranged to coincide with mounting features provided within the tanks of the heat exchangers, such as threaded holes, through-holes, or self-tapping holes.

The surge tank 11 is directly integrated into the top structural frame channel 10 by forming a second U-shaped component 13 and inserting that second U-shaped component 13 into the space between the walls 15, 16 so that the volume 17 of the surge tank is formed. The U-shaped components 12 and 13 are joined together by welding, brazing, gluing, or other joining technique in order provide a generally sealed volume 17.

The fill neck 18, vent port 20, draw-down port 19, and sight glass 22 can be assembled into provided apertures in the component 12 and/or the component 13, and can be joined thereto in order to provide additional leak-free joints. The joining can be done in similar fashion to that described for the components 12 and 13, or it can be accomplished by other known joining methods. In some cases one of the mentioned components may be joined in two or more pieces. For example, the sight glass 22 can include an internally threaded receiver that is welded into an aperture in the wall 15, and an externally threaded sight glass component that is threaded into the receiver.

In some cases, at least some of the aforementioned components are joined to the top structural frame channel 10 after the insertion of the U-shaped component 13 into the U-shaped component 12. For example, it may be preferable to provide a bracket 42 within the surge tank 11 extending over the draw-down port 19 in order to provide for some baffling of the flow through that port 19. The bracket 42 can be pre-assembled to the component 13, and the port 19 can then be subsequently inserted through the wall 15 so that it is received within the pocket formed by the bracket 42 and the component 13.

It can be especially preferable to form the U-shaped component 12 by first cutting a flat blank out of sheet steel, and subsequently forming walls 14, 15, and 16 from the blank through the creation of two right-angle bends. The apertures required for the assembly of various components of the surge tank (for example, the draw-down port 19, the sight glass 22, the vent port 20, and the fill neck 18) can be formed before such forming of the walls, optionally in the same operation as the cutting of the blank. The mounting holes 23 and 27 can be similarly formed, along with notches 41 that are provided to accommodate the fluid ports of the various heat exchangers. In some embodiments, at least some of the mounting holes 23 and/or 27 can be formed as elongated slots.

In some especially preferable embodiments, the walls 15 and 16 of the top structural frame channel 10 are sized to correspond with the heights of the charge air cooler tank 35 and the oil cooler tank 38 over that portion of the cooling module width where the charge air cooler 5 and the oil cooler 6 are located. Similarly, those walls 15 and 16 can be sized to correspond with the total height of the surge tank 11 and the radiator top tank over that portion of the cooling module width where the radiator 4 is located. In addition, the bottom structural frame channel 9 can be of a similar U-shaped construction, with vertically arranged walls that match the heights of the charge air cooler tank 35, the oil cooler tank 38, and the radiator bottom tank 30. In so doing, it can be ensured that the structural frame 7 is not overlapping with the heat exchange cores 28, 34, and 37, so that airflow through those heat exchange cores is not obstructed.

By integrating the surge tank 11 into the cooling module 1 in such a manner, the frontal areas of the radiator 4, charge air cooler 5, and oil cooler 6 can all be maximized. Since all of the mentioned heat exchangers and the surge tank 11 are all located on a common side of the planar wall 14, that wall 14 can be elevated to be in a horizontal orientation at the very top of the engine compartment. This enables an easy integration of the cooling module 1 into the overall engine system, especially in cases where the engine system is a part of a vehicle.

Various alternatives to the certain features and elements of the present invention are described with reference to specific embodiments of the present invention. With the exception of features, elements, and manners of operation that are mutually exclusive of or are inconsistent with each embodiment described above, it should be noted that the alternative features, elements, and manners of operation described with reference to one particular embodiment are applicable to the other embodiments.

The embodiments described above and illustrated in the figures are presented by way of example only and are not intended as a limitation upon the concepts and principles of the present invention. As such, it will be appreciated by one having ordinary skill in the art that various changes in the elements and their configuration and arrangement are possible without departing from the spirit and scope of the present invention.

We claim:

1. A cooling module comprising:
a plurality of heat exchangers, at least one of which is a coolant radiator;
a structural frame channel extending along an end of the cooling module, the plurality of heat exchangers being at least partially secured to the structural frame channel; and
a coolant surge tank integral to the cooling module and in fluid communication with the coolant radiator, the coolant surge tank having a coolant volume bounded by a plurality of walls, at least one of said walls being provided by the structural frame channel.

2. The cooling module of claim 1, wherein the structural frame channel defines a planar wall extending along a width dimension of the cooling module, the plurality of heat exchangers and the coolant surge tank being located on a common side of the planar wall.

3. The cooling module of claim 2, wherein the coolant surge tank is arranged between the planar wall and the coolant radiator.

4. The cooling module of claim 1, wherein each of the plurality of heat exchangers includes a heat exchanger core, and the structural frame channel is non-overlapping with the heat exchanger cores.

5. The cooling module of claim 1, wherein the structural frame channel comprises:
a first planar wall having first and second opposing long edges;
a second planar wall extending along the first long edge and oriented perpendicular to the first planar wall; and
a third planar wall extending along the second long edge and oriented perpendicular to the first planar wall, wherein the first, second, and third planar walls each define one of the plurality of walls bounding the coolant volume.

6. The cooling module of claim 5 wherein the first planar wall, the second planar wall, and the third planar wall together define a first U-shaped section, further comprising:
a fourth planar wall having third and fourth opposing long edges;
a fifth planar wall extending along the third long edge and oriented perpendicular to the fourth planar wall; and
a sixth planar walls extending along the fourth long edge and oriented perpendicular to the fourth planar wall, the fourth planar wall, the fifth planar wall, and the sixth planar wall together defining a second U-shaped section, wherein the second U-shaped section is received within and joined to the first U-shaped section to define the coolant surge tank.

7. The cooling module of claim 5, further comprising a coolant fill neck joined to the first planar wall and extending into the coolant volume.

8. A cooling module installed into an engine system having a coolant circuit, comprising:
a top structural frame channel;
a bottom structural frame channel spaced apart from, and lower than, the top structural frame channel;
a coolant radiator arranged between and secured to the top and bottom structural frame channels, the coolant radiator forming part of the cooling circuit; and
a coolant surge tank provided within the top structural frame channel and located above the coolant radiator, the coolant surge tank forming part of the cooling circuit.

9. The cooling module of claim 7, wherein the coolant surge tank is located at an uppermost position along the coolant circuit.

10. The cooling module of claim 7, wherein the coolant radiator includes an inlet tank and an outlet tank and wherein the coolant surge tank is fluidly coupled to one of the inlet tank and outlet tank by way of a vent port provided at an upper location of the coolant surge tank.

11. The cooling module of claim 9, wherein the inlet tank is secured to the top structural frame channel, the outlet tank is secured to the bottom structural frame channel, and the coolant surge tank is fluidly coupled to the inlet tank.

12. The cooling module of claim 7, further comprising one or more additional heat exchangers secured to the top and bottom structural frame channels.

13. The cooling module of claim 7, wherein the coolant surge tank is fluidly coupled to a lowermost location along the cooling circuit by way of a draw-down port provided at a lower location of the coolant surge tank.

14. The cooling module of claim 7, wherein the top structural frame channel comprises:
a first U-shaped section defined by a first horizontally arranged planar wall joined by first and second vertically arranged planar walls; and
a second U-shaped section defined by a second horizontally arranged planar wall joined by third and fourth vertically arranged planar walls, the second U-shaped section being received within and joined to the first U-shaped section to define the coolant surge tank.

15. A method of making a cooling module with integral surge tank, comprising:
forming a plurality of mounting holes in a first metal sheet;
forming the first metal sheet into a first U-shaped component;
forming a second metal sheet into a second U-shaped component;
arranging the second U-shaped component within the first U-shaped component;
joining the first and second U-shaped components to define an enclosed volume; and
joining a coolant radiator to the first U-shaped component through at least some of the plurality of mounting holes.

16. The method of claim 14, wherein joining the first and second U-shaped components includes welding the second U-shaped component to the first U-shaped component.

17. The method of claim 14, further comprising joining one or more additional heat exchangers to the first U-shaped component through at least some of the plurality of mounting holes.

18. The method of claim 14, wherein the step of joining a coolant radiator to the first U-shaped component includes arranging a top tank of the coolant radiator directly adjacent to the second U-shaped component.
